(19) United States
(12) Patent Application Publication
(10) Pub. No.: US 2011/0270769 A1
(43) Pub. Date: Nov. 3, 2011

(54) PLATFORM AND METHOD FOR INTER-BUSINESS COLLABORATION

(75) Inventors: Sagi Peled, Kfar Saba (IL); Noam Tamarkin, Binyamina (IL)

(73) Assignee: Coolaboration Ltd, Kfar Saba (IL)

(21) Appl. No.: 13/143,200

(22) PCT Filed: Jan. 18, 2010
(86) PCT No.: PCT/IB10/50206

§ 371 Date: Jul. 5, 2011

Related U.S. Application Data
(60) Provisional application No. 61/146,324, filed on Jan. 22, 2009.

(51) Int. Cl. G06Q 10/00

(52) U.S. Cl. 705/301

(57) ABSTRACT

The present invention is a system and method for enhancing inter-business collaboration. According to preferred embodiments of the present invention there is provided a system for inter-business collaboration including a method for inter-business collaboration including the steps of: providing a system for inter-business collaboration including a system platform including a data storage and processing unit, at least one first business registered in the system platform, creating a collaboration agreement between the first business and at least one second business, by the first business utilizing the system platform, wherein the collaboration agreement defines at least one collaboration package including at least one contribution of the first business and at least one contribution of the second business.

### FIELD AND BACKGROUND OF THE INVENTION

The invention is in the field of inter-business collaboration. More specifically, the present invention is a platform and method for enhancing inter-business collaboration. Commonly, businesses activity, in retailers and service providers, is characterized by using technologically advanced cash register systems as a means of supervising and controlling sales and prices such as price lists and discounts. The cash registers and similar systems commonly used and known suffer from a latent deficiency inasmuch as cash registers and similar systems do not facilitate collaboration with other businesses and thus do not add benefits and discount opportunities to the potential customer as part of a collaboration.

Although “web sites” consisting of a variety of small businesses of a similar nature are known in the art wherein the businesses offer discounts on the web site, (such as www.bedandbreakfast.com offering discounts in restaurants and tourist attraction) the “web sites” do not facilitate collaboration with other businesses.

There exist also “business networking web sites” (such as www.pinpoint.co.il or www.linkedin.com) offering decision makers a business platform for networking and creating business opportunities online as well as the option of encountering business partners or new clients. However, “business networking web sites” do not facilitate collaboration between businesses.

There is therefore a need for a platform readily facilitating business collaboration with other businesses.

Furthermore, it is well known that common business collaboration attempts involve a time-consuming and complex process starting with repeated phone conversations, multiple meetings and eventually reaching a possible tenuous outcome of a complicated legal agreement which requires further negotiations, vetting and renditions. The business collaborations known in the art are not computerized and do not systematically monitor and/or control business collaborations.

Thus, there is yet a further unmet need for a platform for creating an individual business profile, defining an identity by marking relevant tags and/or creating and managing joint ventures or collaborations as well as sale options with other collaborating businesses participating within the platform system.

There is therefore an unmet need for a platform that allows its users complete freedom of action in its collaboration initiatives. System that will enable businesses to discover innovative and creative collaboration ventures.

### BRIEF SUMMARY OF THE INVENTION

The present invention is a system and method for enhancing inter-business collaboration. According to preferred embodiments of the present invention there is provided a method for inter-business collaboration including the steps of providing a system for inter-business collaboration including a system platform including a data storage and processing unit, at least one first business registered in the system platform, creating a collaboration agreement between the first business and at least one second business, by the first business utilizing the system platform, wherein the collaboration agreement defines at least one collaboration package including at least one contribution of the first business and at least one contribution of the second business.

According to further embodiments of the present invention there is provided a system for inter-business collaboration including a system platform including a data storage and processing unit, and at least one end unit readily communicating with the system platform.

According to still further embodiments of the present invention there is provided a method for inter-business collaboration including the steps of providing a system for inter-business collaboration including a system platform including a data storage and processing unit, at least one business readily communicating with the system platform, creating a certificate by the business in accordance with data in the system platform which cannot by used in the same the business, and utilizing the certificate, creating a collaboration agreement by the business utilizing the system platform, sending the collaboration agreement to at least one intended recipient, receiving at least one acceptance from the at least one intended recipient, and issuing the certificate for utilization.

### BRIEF DESCRIPTION OF THE DRAWINGS

FIG. 1 is a schematic layout of a system platform with a first end unit and at least one second end unit according to the present invention;

FIG. 2 is a flowchart of the registration and coalition builder phase according to the present invention;

FIG. 3 is a flowchart of the collaboration phase according to the present invention;

FIG. 4 is a flowchart of a publication/certificate issue phase according to the present invention;

FIG. 5 is a flowchart of the certificate realization phase according to the present invention; and

FIG. 6 is a flowchart of the reports and balance phase according to the present invention.

### DETAILED DESCRIPTION OF THE PREFERRED EMBODIMENTS

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

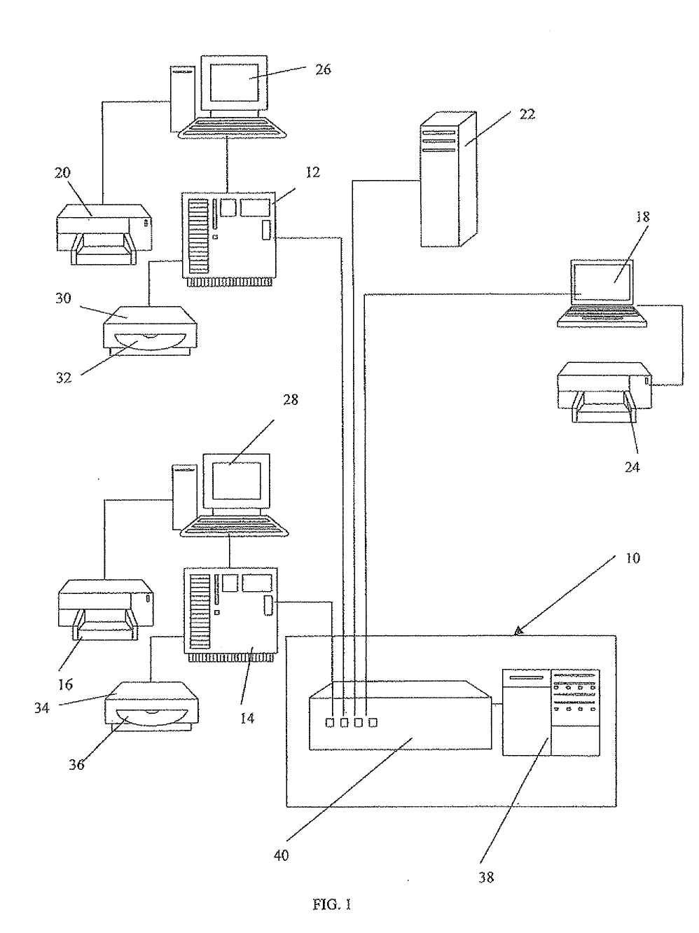

FIG. 1 is a schematic layout of a system platform 10 and end unit according to the present invention.

Preferably, system platform 10 includes a central data storage and processing unit 38 and a router 40. Thus, it is envisaged to use system platform in wired format wherein a plurality of businesses within geographical proximity (such as building, malls and shopping centers) can use system platform and use wired communications. Central data storage and processing unit 38 is geared towards readily storing collaborations, transactions, coupons, statistics, reports, history of successful collaborations, templates of collaborations agreements and the like.

Preferably, router 40 is geared towards either wired or wireless communication between system platform 10 and at least one business (at least one first end unit 12 and/or at least one second end unit 14)

Preferably, the system platform 10 initiates at a start registration and coalition builder. Occasioning on user in system platform 10 being a new user and subsequent to user completing a registration process in first end unit 12 the user (a Business) receives a system membership in system platform 10.

Optionally, first end unit 12 includes a first storage unit 30 for readily storing transactions, coupon and the like. Preferably, first storage unit 30 is readily operated with a first smart key 32. Preferably, first smart key 32 prevents unauthorized access to first storage unit 30 and the information stored therein.

Optionally, second end unit 14 includes a second storage unit 34 for readily storing transactions, coupon and the like. Preferably, second storage unit 34 is readily operated with a second smart key 36. Preferably, second smart key 36 prevents unauthorized access to second storage unit 34 and the information stored therein.

Preferably, registration parameters can include, but are not limited to, a user name, a password, a name of business, an e-mail, a phone number, an areas of practice, a settlement, a district, a layout of chain stores, a customer profile, an areas of practice of the business to collaborate with, a collaboration frequency, a logo, a link to the web site of the business, whether a real business or a virtual business, applies a licensed dealer number, a business description, a method through which the business came to learn about the platform, and a kind of subscriber.

Preferably, system platform 10 can control a mechanism for checking according to kind of subscriber and the activities the business can do. By way of example only, the system platform 10 can control a mechanism for checking how many active collaborations the business can use at same time.

Optionally, occasioning on user of first end unit 12 being a registered user, the user of first end unit 12 performs a login.

Preferably, a coalition builder potential members/coalition partners search in system platform 10 is performed according to coalition builder parameters by user of first end unit 12.

Preferably, coalition builder parameter can include but are not limited to, a name of business, an area of practice, a settlement, a district, a layout of chain stores, a customer profile, a business which defines in the profile that the business wishes to make collaborations with businesses in a specific area of practice, a coalition accordingly to their kind of collaboration, a data from the platform's collaboration like businesses with collaboration successes, a businesses in “my friends list”, a “my hot list”, a “my tracking list” and the most watched businesses.

Substantially thereafter, a refining of coalition builder search results by first end unit 12 is performed as well as a coalition builder invitation is sent to at least one existing member or existing coalition (second end unit 14) prior to examining of an invitation has been accepted. Optionally, the invitation can be sent with the system platform 10 by way of an inside mail, an e-mail, an SMS, an instant messenger, and the like.

System platform 10 checks whether an invitation has been accepted. Occasioning on an invitation being accepted, a coalition is either established or an additional member is added to the coalition.

Optionally, first end unit 12 preferably offers an option of using an existing coalition by user of first end unit 12.

System platform 10 optionally offers an option of using an existing coalition by user of first end unit 12.

Occasioning on a negative response to use coalition, a recipient selection is performed by user of first end unit 12 prior to reaching a create collaboration agreement. Recipient selection is selected, by way of example only, from the group consisting of an area of practice, a settlement, a layout of chain stores, a customer profile, a business wanting to create/join a collaboration with at least one business in the areas of practice, a coalition according to the kind of collaboration, a data segment from the platform system's collaboration such as businesses with at least one collaborations success.

Optionally, recipient selection can include recipients which have not completed registration process and/or not received system membership. Thus, it is envisaged that a business registered in the system platform can readily collaborate with “external” business which do not use system platform 10.

If use coalition is selected, an option of using all members is offered. Thus, from the selection of use coalition until subsequent to selecting members, the potential members of the collaboration are defined in system platform 10. If not all members of the coalition are selected, a member selection by user of first end unit 12 is used to select the recipients of the collaboration agreement.

Substantially thereafter, a creation of a collaboration agreement is initiated in system platform 10. To this end, a new agreement is offered. Occasioning on an existing agreement template being preferred a selection of collaboration template from the system platform 10 is performed. Occasioning on a new collaboration agreement being preferred, a new collaboration agreement without a template is created in system platform 10.

Preferably, agreements created (either with a template or without a template) includes parameters which can include, by way of example, an issue certificate, at least one collaboration conditions, a starting date of the collaboration and/or an expiry date of the collaboration, a number of coupons in the collaboration, a description of what each collaboration's member give to the other collaboration members in money or in everything else.

Preferably, collaboration conditions can, by way of example only, include a stipulation such as if a customer buys a specific product or service in a first business, then the customer shall receive a certain incentive/remuneration in a second business. A further non-limiting example, can include a collaboration condition such as if a customer buys from a first business at a value exceeding a predetermined amount, the customer shall receive a discount at a predetermined level at a second business.

A draft collaboration agreement is distributed by system platform 10 to potential collaboration members (second end unit 14) and the system platform 10 awaits for a collaboration agreement draft to be accepted.

Occasioning on collaboration agreement draft receiving a modification by second end unit 14, a collaboration update is created in system platform 10 and distributed to collaboration members. Substantially thereafter, the system platform 10 awaits the updated draft collaboration agreement to be accepted as above.

Occasioning on the collaboration draft agreement being accepted, a sending of collaboration agreement to actual collaboration members (first end unit 12 and second end unit 14) is performed by system platform 10.

Preferably, every collaboration agreement defines a package to customer with at least one contribution of each collaboration member.

Thus, subsequent to accepting draft, the actual members of the collaboration are defined.

Preferably, system platform 10 publishes an end user campaign exposure screen.

Preferably, end user campaign exposure screen is geared towards readily facilitating a goal which, by way of example only, can include enabling a search of collaborations to the end user/the potential customer (in end user computer 18) with parameters including but not limited to: a name of business, a name of collaboration, a name of item in the collaboration, an area of practice, a settlement, a district, a layout of chain stores, a customer profile, a data segment from the platform system's collaboration including at least one businesses with at least one collaboration was success.

Preferably, end user campaign exposure screen readily facilitates an end user knowing (in an end user computer 18) about the collaborations as well as facilitating producing a coupon of the collaboration and print it in an end user printer 24 according to the interests of an end user.

Preferably, system platform 10 facilitates a selection of publication channels and a publishing to selected channels.

Preferably, publication channels can include, but are not limited to, a cash register of the collaboration members, a vertical site such as www.bedandbreakfast.com, a coupon site, a yellow pages entry, at least one television broadcast/channel, a billboard and a newspaper. In every selected channel the end user (the potential customer) in end user computer 18 can know about the collaborations and produce a coupon of a collaboration the end user is interested in, and print it in end user printer 24

Occasioning on the certificate issuer being a virtual certificate issuer, as defined in the collaboration, the platform system sends at least one collaboration parameter to a virtual business system 22. If there is an eligible sale, virtual business system 22 sends a transaction details to system platform 10. Substantially thereafter the system platform 10 produces a certificate and sends the certificate with eligible collaboration businesses for realization to customers (end user computer 18). System platform 10 also sends a certificate ID with collaboration parameters to business collaboration eligible for realization (first end unit 12 and/or second end unit 14).

Occasioning on virtual business not having an “eligible sale” the virtual business system 22 awaits an eligible sale.

Occasioning on certificate issuer being a real certificate issuer a first user computer 26, or a second user computer 28, ascertains whether an eligible sale occurs.

If an eligible sale does not occur, first user computer 26, or second user computer 28 awaits an eligible sale.

Responsive to an eligible sale, issuing business opens a collaboration certificate screen (at first end unit 12 or second end unit 14 depending on what defined in the collaboration) and issuing business produces a new certificate at first end unit 12 or second end unit 14. Furthermore, issuing business provides a certificate to the customer at first user computer 26 with a first user printer 20, or second user computer 28 with a second user printer 16.

By way of example only, certificate issuer can produce a new certificate by of a coupon, a voucher, an SMS message, an e-mail, a television coupon and the like.

Optionally, responsive to an eligible sale, an end-user opens a collaboration certificate screen in the end user computer 18 and produces a new certificate and prints it in end user printer 24.

By way of example only, an end user can produce a new certificate by of a coupon, a voucher, an SMS message, an e-mail, a television coupon and the like.

Preferably, first user computer 26 and/or second user computer 28 and/or a virtual business system 22 ascertains whether a valid transaction and a valid certificate is being realized. Until ascertains that both a valid certificate is being realized and a valid transaction has been completed prior to proceeding to ascertaining if a business, in which the certificate is being realized, as defined in the collaboration is “real” or “virtual”. Preferably, for the certificate being realized virtual business system 22 obtains the certificate and calculates the benefit for customer.

Preferably, virtual business system 22 finalizes sale with customer and sends a report of use of certificate to system platform 10.

Occasioning on a “real” business, in which certificate is being realized, the real business obtains the certificate (at first end unit 12 or second end unit 14 depending on what defined in the collaboration) as well as real business calculating a benefit for customer (at first user computer 26 or second user computer 28 depend on what defined in the collaboration) and real business finalizing a sale with the customer.

Substantially thereafter, the real business reports using the certificate to system platform 10.

First end unit user 12 and/or second end unit user 14 and/or virtual business system 22 starts the reports and balance phase. A selection of at least one report which reports can include, by way of example only, a display of at least one system recommendation.

Optionally, collaboration members can “report” and/or “rate” a collaboration to system platform 10. The “reports” and/or “ratings” of a collaboration by a collaboration member can include, by way of example only, whether the collaborations was a “success”, rate the level of “success” of a collaboration, at least one improvement suggestion, at least one feedback on a collaboration and the like.

At least one report includes, by way of example only, a report selected from the group consisting of a “how many collaborations that was my initiative” report, a “how many collaborations, according to other business initiatives were done with my business” report, a “how many coupons were realized in any collaboration” report, a “how many collaborations I have done in each month” report, a “recommendation to collaboration” based on post-analysis data collected in the platform system report.

An non-limiting example for a “recommendation to collaboration” based on post-analysis data collected in the platform system report includes data on best successes in collaborations according to business areas of practice determined according to a predetermined and/or first end unit user 12 and/or second end unit user 14 and/or virtual business system user 22 criteria.

Predetermined criteria according first end unit user 12 and/or second end unit user 14 and/or virtual business system user 22 can include, by way of example only, successes with businesses from a specific areas of practice, the kind of templates which yielded the most financially viable collaborations.

Optionally and by way of example only, first end unit user 12 and/or second end unit user 14 and/or virtual business system user 22 can select a balance report.

If selecting a balance report is confirmed, a selection of parameters is performed as well as displaying a balance according to the parameters.

Preferably, parameters selected can include, but are not limited to, a name of business, an e-mail, a phone number, an areas of practice, a settlement, a district, a layout of chain stores, a customer profile, an areas of practice of the business to collaborate with, a collaboration frequency, a link to the web site of the business, whether a real business or a virtual business, applies a licensed dealer number, a business description, a method through which the business came to learn about the platform, and a kind of subscriber.

Substantially thereafter an activation of “auto-balancing” is offered. If “auto-balance” is selected, an “auto-balance” is performed by the system platform 10.

The term “auto-balance” as used herein, shall include but will not be limited to, a balance report showing the credit balance and/or the debit balance with each business in the collaboration.

Preferably, auto-balance readily facilitates transfer of funds between each business automatically, in accordance with balance report.

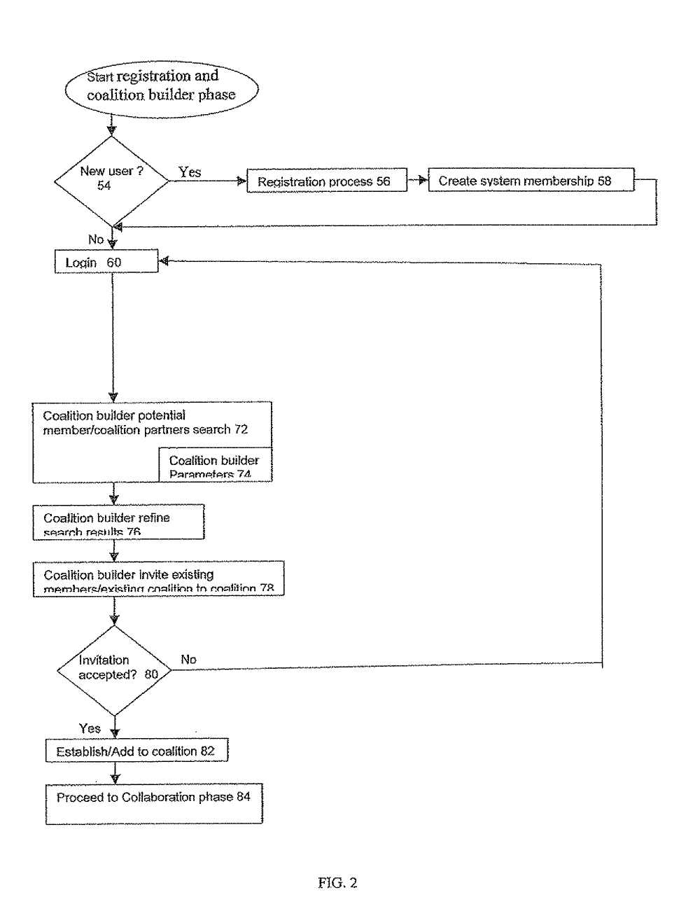

FIG. 2 illustrates a registration and coalition builder phase of using a platform system according to the present invention. Preferably, the platform system initiates at a start registration and coalition builder phase 52. Occasioning on user 54 being a new user and subsequent to user 54 completing a registration process 56 user 54 receives a system membership 58.

Preferably, registration parameters can include, but are not limited to, a user name, a password, a name of business, an e-mail, a phone number, an areas of practice, a settlement, a district, a layout of chain stores, a customer profile, an areas of practice of the business to collaborate with, a collaboration frequency, a logo, a link to the web site of the business, whether a real business or a virtual business, applies a licensed dealer number, a business description, a method through which the business came to learn about the platform, and a kind of subscriber.

Preferably, the platform system can control a mechanism for checking according to kind of subscriber and the activities the business can do. By way of example only, the platform system can control a mechanism for checking how many active collaborations the business can use at same time.

Optionally, occasioning on user 54 being a registered user 54, user 54 performs a login 60.

Preferably, a coalition builder potential members/coalition partners search 72 is performed according to coalition builder parameters 74.

Preferably, coalition builder parameter 74 can include but are not limited to, a name of business, an area of practice, a settlement, a district, a layout of chain stores, a customer profile, a business which defines in the profile that the business wishes to make collaborations with businesses in a specific area of practice, a coalition accordingly to their kind of collaboration, a data from the platform's collaboration like businesses with collaboration successes, a businesses in “my friends list”, a “my hot list”, a “my tracking list” and the most watched businesses.

Substantially thereafter, a refining of coalition builder search results 76 is performed as well as a coalition builder invitation is sent to at least one existing member or existing coalition 78 prior to examining of an invitation has been accepted 80. Optionally, the invitation can be sent with the platform system by way of an inside mail, an e-mail, an SMS, an instant messenger, and the like.

The platform system checks whether an invitation has been accepted 80. As long as no invitation has been accepted platform system awaits either returning to the login 60.

Occasioning on an invitation being accepted a coalition is either established or an additional member is added to the coalition 82. Substantially thereafter, the platform system proceeds to collaboration phase 84.

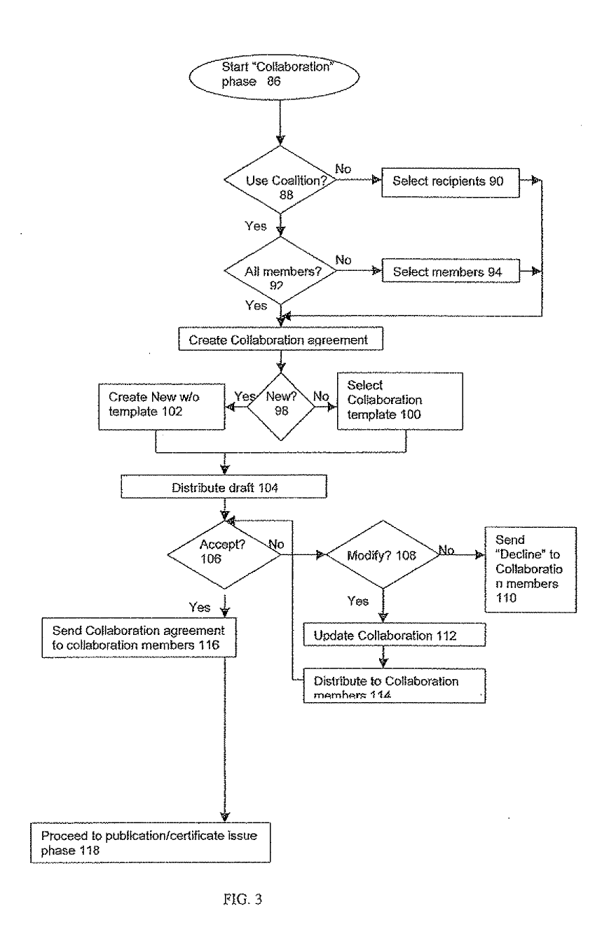

FIG. 3 shows a flowchart of the collaboration phase. A start collaboration phase 86 initiates and thereafter an option of use existing coalition 88 is offered. Occasioning on a negative response to use coalition 88, a recipient selection 90 is performed prior to reaching a create collaboration agreement 96. Recipient selection 90 is selected, by way of example only, from the group consisting of an area of practice, a settlement, a layout of chain stores, a customer profile, a business wanting to create/join a collaboration with at least one business in the areas of practice, a coalition according to the kind of collaboration, a data segment from the platform system's collaboration such as businesses with at least one collaborations success.

Optionally, recipient selection can include recipients which have not completed registration process 56 and/or not received system membership 58. Thus, it is envisaged that a business registered in the system platform can readily collaborate with “external” business which do not use the system platform.

If use coalition is selected, an option of using all members 92 is offered. Thus, from the selection of use coalition 88 until subsequent to selecting members 94, the potential members of the collaboration are defined. If not all members of the coalition are selected, a member selection 94 is used to select the recipients of the collaboration agreement.

Substantially thereafter, a creation of a collaboration agreement is initiated 96. To this end, a new agreement is offered 98. Occasioning on an existing agreement template being preferred a selection of collaboration template 100 is performed. Occasioning on a new collaboration agreement being preferred, a new collaboration agreement without a template is created 102.

Preferably, agreements created (either with a template or without a template) includes parameters which can include, by way of example, an issue certificate, at least one collaboration conditions, a starting date of the collaboration and/or an expiry date of the collaboration, a number of coupons in the collaboration, a description of what each collaboration's member give to the other collaboration members in money or in everything else.

Preferably, collaboration conditions can, by way of example only, include a stipulation such as if a customer buys a specific product or service in a first business, then the customer shall receive a certain incentive/remuneration in a second business. A further un-limiting example, can include a collaboration condition such as if a customer buys from a first business at a value exceeding a predetermined amount, the customer shall receive a discount at a predetermined level at a second business.

A draft collaboration agreement is distributed 104 to potential collaboration members and the platform system waits for a collaboration agreement draft to be accepted 106.

Occasioning on collaboration agreement draft receiving a modification 108, a collaboration update 112 is created and distributed to collaboration members 114. Substantially thereafter, the platform system awaits the updated draft collaboration agreement to be accepted as above.

Occasioning on a collaboration member wishing neither to accept nor to modify draft collaboration agreement a “decline” message is to collaboration members 110.

Occasioning on the collaboration draft agreement being accepted 106, a sending of collaboration agreement to actual collaboration members is performed 116 and thereafter the platform system proceeds to publication/certificate issue phase 118.

Preferably, every collaboration agreement defines a package to customer with at least one contribution of each collaboration member.

Thus, subsequent to accepting draft 106, the actual members of the collaboration are defined.

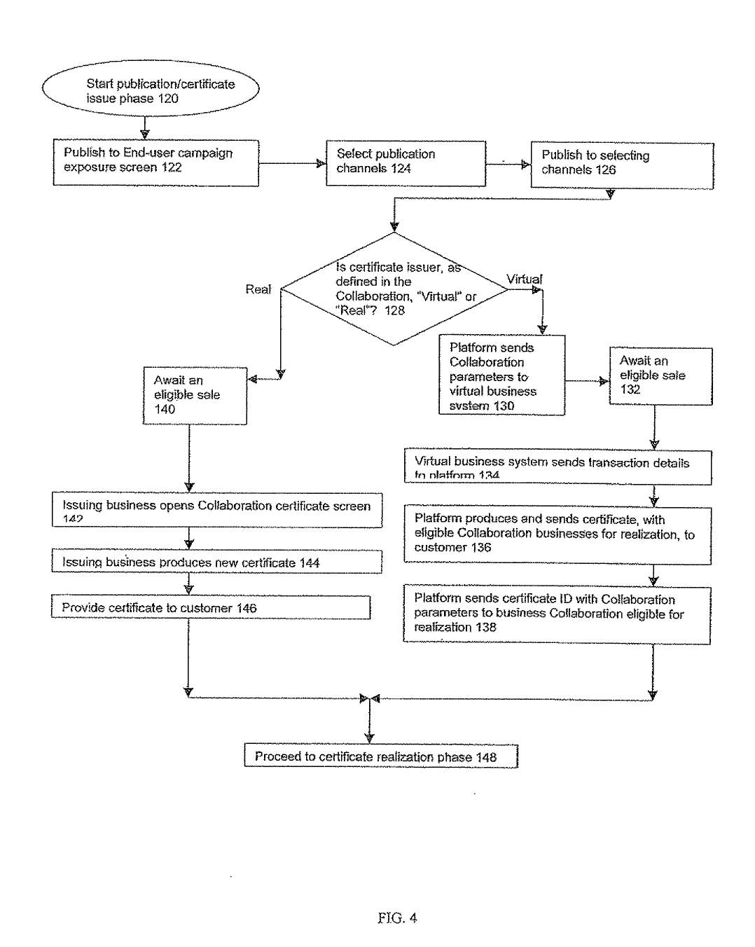

FIG. 4 shows a flowchart of a publication/certificate issue. As shown in FIG. 4, a publication/certificate issue phase is started 120. The platform system proceeds to a publishing of an end user campaign exposure screen 122.

Preferably, end user campaign exposure screen 122 is geared towards readily facilitating a goal which, by way of example only, can include enabling a search of collaborations to the end user/the potential customer with parameters including but not limited to: a name of business, a name of collaboration, a name of item in the collaboration, an area of practice, a settlement, a district, a layout of chain stores, a customer profile, a data segment from the platform system's collaboration including at least one businesses with at least one collaboration was success.

Preferably, end user campaign exposure screen 122 readily facilitates an end user can know about the collaborations as well as facilitating producing a coupon of the collaboration according to the interests of an end user.

Preferably, system platform facilitates a selection of publication channels 124 and a publishing to selected channels 126.

Preferably, publication channels 124 can include, but are not limited to, a cash register of the collaboration members, a vertical site such as www.bedandbreakfast.com, a coupon site, a yellow pages entry, at least one television broadcast/channel, a billboard and a newspaper. In every selected channel 126 the end user (the potential customer) can know about the collaborations and produce a coupon of a collaboration the end user is interested in.

Occasioning on the certificate issuer being a virtual certificate issuer 128, as defined in the collaboration, the platform system sends at least one collaboration parameter to a virtual business system 130. If there is an eligible sale 132 the virtual business sends a transaction details to platform system at 134. Substantially thereafter the platform system produces a certificate and sends the certificate with eligible collaboration businesses for realization to customers 136. The platform system also sends a certificate ID with collaboration parameters to business collaboration eligible for realization 138.

Substantially thereafter the platform system proceeds to certificate realization phase 148.

Occasioning on virtual business not having an “eligible sale” 132 the virtual business awaits an eligible sale.

Occasioning on certificate issuer being a real certificate issuer at 128 the certificate issuer ascertains whether an eligible sale 140 occurs.

If an eligible sale 140 does not occur, the certificate issuer awaits an eligible sale.

Responsive to an eligible sale 140, issuing business opens a collaboration certificate screen 142 and issuing business produces a new certificate 144. Furthermore, issuing business provides a certificate to the customer 146 and proceeds to certificate realization phase 148.

By way of example only, certificate issuer can produce a new certificate 144 by of a coupon, a voucher, an SMS message, an e-mail, a television coupon and the like.

Optionally, responsive to an eligible sale 140, an end-user opens a collaboration certificate screen 142 and produces a new certificate 144.

By way of example only, an end user can produce a new certificate 144 by of a coupon, a voucher, an SMS message, an e-mail, a television coupon and the like.

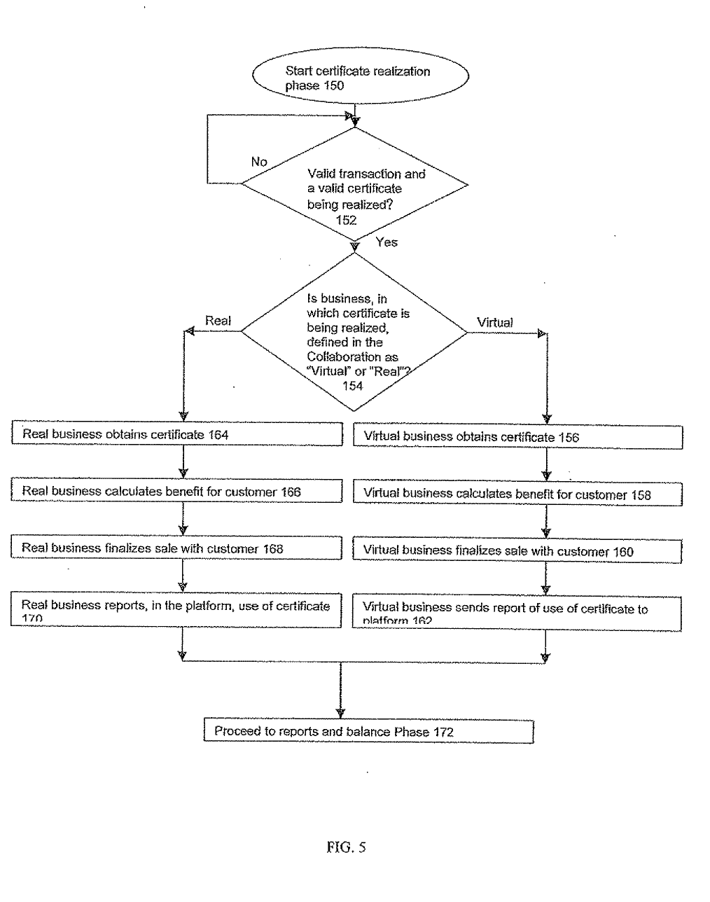

FIG. 5 shows a flowchart of the certificate realization phase. As shown in FIG. 5, a certificate realization phase 150 starts and the business, in which the certificate is being realized, as defined in the collaboration, ascertains whether a valid transaction and a valid certificate is being realized 152. Until the business ascertains that both a valid certificate is being realized and a valid transaction has been completed prior to proceeding to ascertaining if a business, in which the certificate is being realized, as defined in the collaboration is “real” or “virtual” at 154. A virtual business, in which the certificate is being realized, then obtains the certificate 156, thereafter virtual business calculates the benefit for customer 158 and virtual business finalizes sale with customer 160 and virtual business sends report of use of certificate to platform system 162. Substantially thereafter, the platform system proceeds to report and balance phase 172.

Occasioning on a “real” business, in which certificate is being realized 154, the real business obtains the certificate 164 as well as real business calculating a benefit for customer 166 and real business finalizing a sale with the customer 168.

Substantially thereafter, the real business reports using the certificate in the platform 170. Thereafter, the platform system proceeds to report and balance phase 172.

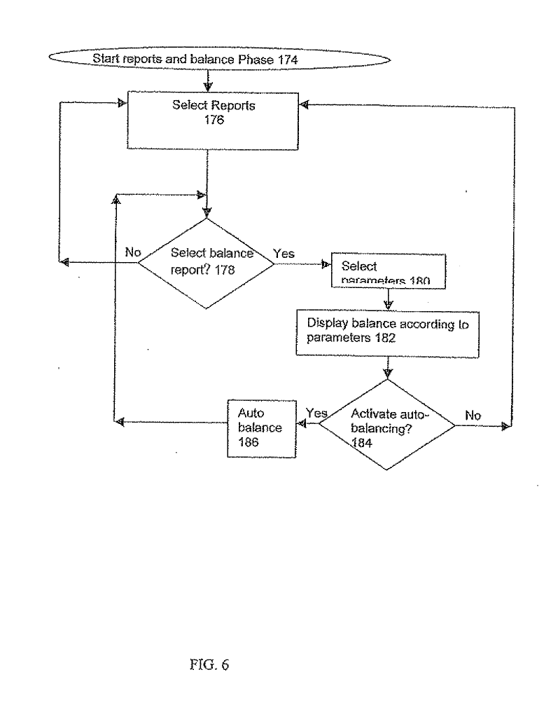

FIG. 6 shows a flowchart of the reports and balance phase. As shown in FIG. 6, The platform system starts the reports and balance phase 174. A selection of at least one report 176 which reports can include, by way of example only, a display of at least one system recommendation.

Optionally, collaboration members can “report” and/or “rate” a collaborations at reports and balance phase 174. The “reports” and/or “ratings” of a collaboration by a collaboration member can include, by way of example only, whether the collaborations was a “success”, rate the level of “success” of a collaboration, at least one improvement suggestion, at least one feedback on a collaboration and the like.

At least one report 176 includes, by way of example only, a report selected from the group consisting of a “how many collaborations that was my initiative” report, a “how many collaborations, according to other business initiatives were done with my business” report, a “how many coupons were realized in any collaboration” report, a “how many collaborations I have done in each month” report, a “recommendation to collaboration” based on post-analysis data collected in the platform system report.

An non-limiting example for a “recommendation to collaboration” based on post-analysis data collected in the platform system report includes data on best successes in collaborations according to business areas of practice determined according to a predetermined and/or user 54 criteria.

Predetermined and/or user 54 criteria can include, by way of example only, successes with businesses from a specific areas of practice, the kind of templates which yielded the most financially viable collaborations.

Optionally and by way of example only, as shown in FIG. 6, a user can select a balance report 178.

If a balance report 178 is not selected the platform system awaits selecting at least one report.

If selecting a balance report 178 is confirmed, a selection of parameters is performed 180 as well as displaying a balance according to the parameters 182.

Preferably, parameters selected can include, but are not limited to, a name of business, an e-mail, a phone number, an areas of practice, a settlement, a district, a layout of chain stores, a customer profile, an areas of practice of the business to collaborate with, a collaboration frequency, a link to the web site of the business, whether a real business or a virtual business, applies a licensed dealer number, a business description, a method through which the business came to learn about the platform, and a kind of subscriber.

Substantially thereafter an activation of “auto-balancing” is offered 184. If activation of “auto-balance” is declined, the platform system returns to select at least one report 176.

If “auto-balance” is selected, an “auto-balance” is performed 186 by the platform system prior to the platform system returning to select balance report 178.

The term “auto-balance” as used herein, shall include but will not be limited to, a balance report 180 showing the credit balance and/or the debit balance with each business in the collaboration.

Preferably, auto-balance 186 readily facilitates transfer of funds between each business automatically, in accordance with balance report 180.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. A method for inter-business collaboration comprising the steps of:
a.) providing a system for inter-business collaboration including:
i) a system platform including a data storage and processing unit;
ii) at least one first business registered in said system platform;
b) creating a collaboration agreement between said first business and at least one second business, by said first business utilizing said system platform, wherein said collaboration agreement defines at least one collaboration package including at least one contribution of said first business and at least one contribution of said second business.

2. The method of claim 1, further comprising the step of publishing said at least one collaboration package to an end-user campaign exposure screen.

3. The method of claim 1, further comprising the step of publishing said at least one collaboration package to a selection of channels.

4. The method of claim 1, further comprising the step of producing a new certificate by a business defined in said collaboration package.

5. The method of claim 4, further comprising the step of realizing said new certificate.

6. The method of claim 1, further comprising the step of building a coalition.

7. The method of claim 1, further comprising the step performing a reports phase.

8. The method of claim 7, further comprising the step performing an auto balancing.

9. A system for inter-business collaboration comprising:
a.) a system platform including a data storage and processing unit; and
b.) at least one end unit readily communicating with said system platform.

10. The system of claim 9, further comprising a certificate created by said end unit in accordance with data in said system platform.

11. The system of claim 9, further comprising an end user utilizing said certificate.

12. The system of claim 9, further comprising a customer utilizing said certificate.

13. A method for inter-business collaboration comprising the steps of:
a.) providing a system for inter-business collaboration including:
i) a system platform including a data storage and processing unit;
ii) at least one business readily communicating with said system platform;
iii) creating a certificate by said business in accordance with data in said system platform which cannot by used in the same said business; and
iv) utilizing said certificate;
b) creating a collaboration agreement by said business utilizing said system platform;
c) sending said collaboration agreement to at least one intended recipient;
d) receiving at least one acceptance from said at least one intended recipient; and
e) issuing said certificate for utilization.

14. The method of claim 13 further comprising the step of creating a collaboration agreement between said at least one business and a at least one second business, by said at least one business utilizing said system platform, wherein said collaboration agreement defines at least one collaboration package including at least one contribution of said at least one business and at least one contribution of said at least one second business.
